(19) United States
(12) Patent Application Publication
(10) Pub. No.: US 2017/0292580 A1
(43) Pub. Date: Oct. 12, 2017

(54) SHOCK ABSORBER

(71) Applicant: KYB Corporation, Tokyo (JP)

(72) Inventors: Satoru TAKEO, Gifu (JP); Toshiharu KAWABE, Aichi (JP)

(73) Assignee: KYB Corporation, Tokyo (JP)

(21) Appl. No.: 15/511,393

(22) PCT Filed: Oct. 13, 2015
(86) PCT No.: PCT/JP2015/078945

§ 371 Date: Mar. 15, 2017

(30) Foreign Application Priority Data
Oct. 14, 2014 (JP) 2014-210058

(51) Int. Cl. F16F 9/56; F16F 9/38; F16F 9/32

(52) U.S. Cl. CPC F16F 9/56; F16F 9/3242; F16F 9/38; F16F 2230/0041; F16F 2230/0023

(57) ABSTRACT

A shock absorber includes a tube that has one end from which a piston rod extends, a capping member disposed in an end portion at a side of the one end in the tube, the capping member including a locking portion formed on an outer peripheral surface, and a cover member disposed in a distal end side of the piston rod, the cover member including a locked portion locked to the locking portion formed on an inner peripheral surface, wherein the shock absorber is kept in a contracted state by the locked portion of the cover member being locked to the locking portion of the capping member.

### TECHNICAL FIELD

The present invention relates to a shock absorber.

### BACKGROUND ART

In order to prevent, such as cavitation in an operating fluid, a shock absorber that is used, for example, in an automobile is known to charge compressed gas within a tube. Such shock absorber is usually in the most extended state by a reactive force of the compressed gas.

Meanwhile, there is a desire to keep the shock absorber in a contracted state until the shock absorber is assembled in an automobile or similar machine in order to improve a conveyance efficiency of the shock absorber and a work efficiency of assembling to the automobile or similar machine.

A shock absorber described in JP2009-36265A includes a locking member disposed in an end portion of a tube on a side from which a piston rod extends and a cover member disposed in a side of a distal end of the piston rod. The locking member and the cover member include respective engaging portions. Engaging the engaging portions keeps the shock absorber in the contracted state.

### SUMMARY OF INVENTION

In the above-described shock absorber, an engaging portion of a locking member is formed by cutting and raising the locking member to a side of a cover member and an engaging portion of the cover member is formed by cutting and raising the cover member to a side of the locking member. With this structure, interference is caused between the engaging portion of the locking member and the engaging portion of the cover member near the most contracted length when the shock absorber is in contraction operation. This causes a problem that a stroke of the shock absorber is restricted.

An object of the present invention is to provide a shock absorber that is configured to be kept in a contracted state with the reduced influence on a stroke.

According to one aspect of the present invention, a shock absorber includes a tube that has one end from which a piston rod extends, a capping member disposed in an end portion at a side of the one end in the tube, the capping member including a locking portion formed on an outer peripheral surface, and a cover member disposed in a distal end side of the piston rod, the cover member including a locked portion locked to the locking portion formed on an inner peripheral surface, wherein the shock absorber is kept in a contracted state by the locked portion of the cover member being locked to the locking portion of the capping member.

### BRIEF DESCRIPTION OF DRAWINGS

FIG. 1 is a partial cross-sectional view illustrating a shock absorber according to a first embodiment of the present invention.

FIG. 2 is a development diagram of a capping member.

FIG. 3 is a partial cross-sectional view illustrating a shock absorber according to a second embodiment of the present invention.

FIG. 4 is a drawing illustrating a modification of a cover member.

FIG. 5 is a drawing illustrating a modification of the capping member.

### DESCRIPTION OF EMBODIMENTS

### First Embodiment

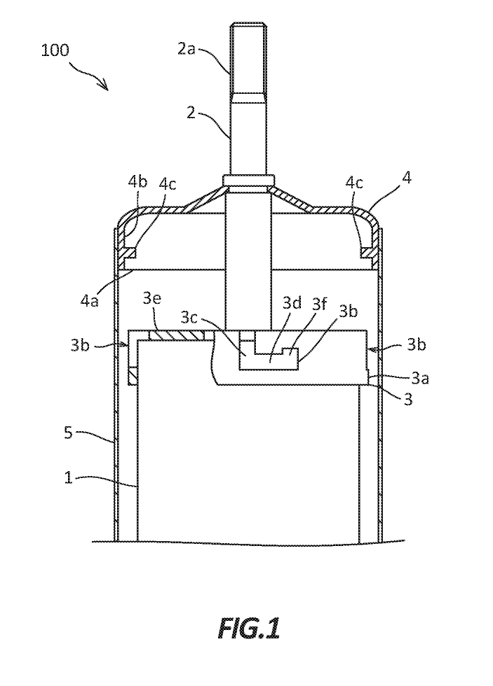

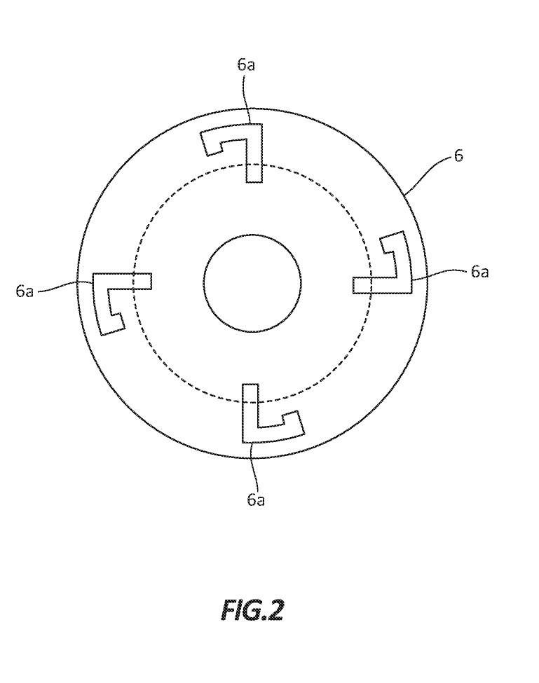

The following describes a shock absorber 100 according to a first embodiment of the present invention by referring to FIG. 1 and FIG. 2.

The shock absorber 100 is interposed between, for example, a vehicle body and an axle shaft of an automobile (not illustrated). The shock absorber 100 is a device that generates a damping force to reduce a vibration of the vehicle body.

As illustrated in FIG. 1, the shock absorber 100 includes a tube 1, which is charged with an hydraulic oil, a piston rod 2, which extends from the tube 1, a capping member 3, which is disposed in an end portion of the tube 1 on a side from which the piston rod 2 extends, a cover member 4, which is disposed in a distal end portion of the piston rod 2, and an outer cover 5, which is disposed on the cover member 4.

The shock absorber 100 may be a mono-tube type or may be a twin-tube type. In the case where the shock absorber 100 is the mono-tube type, the tube 1 is a cylinder. In the case where the shock absorber 100 is a twin-tube type, the tube 1 is an outer tube.

In the tube 1, the operating fluid is charged and the compressed gas is charged for, for example, the prevention of the cavitation in the operating fluid.

The piston rod 2 is inserted in the tube 1 so as to freely advance and retreat. In an end portion of the piston rod 2 on a side extending from the tube 1, an external thread 2a for installing the shock absorber 100 to the vehicle body is formed.

The capping member 3 is a press forming item in a shape of a cylinder with a closed bottom. The capping member 3 is press-fitted in an end portion of the tube 1. On an outer peripheral surface 3a of the capping member 3, depressed portions 3b as locking portions are formed at four equally divided positions in a circumferential direction. The depressed portion 3b includes a longitudinal groove portion 3c extending in an axial direction and a lateral groove portion 3d continuing from the longitudinal groove portion 3c and extending in the circumferential direction. The lateral groove portion 3d has a terminating end portion forming a wide portion 3f that expands the width in a side of a top surface 3e of the capping member 3.

The capping member 3 of this embodiment is formed by folding a circular metal plate 6 at a position indicated by a dashed line as illustrated in FIG. 2. The depressed portions 3b of the capping member 3 are formed by disposing L-shaped slits 6a in the metal plate 6. The slit 6a has an end portion in a center side of the metal plate 6. The end portion is disposed so as to cross over the folding position (the dashed line). This makes the longitudinal groove portion 3c to extend to the top surface 3e, as illustrated in FIG. 1, after the capping member 3 is formed. The depressed portion 3b will be described in detail later.

The cover member 4 is a press forming item in a shape of a cylinder with a closed bottom. The cover member 4 is secured in a side of the distal end of the piston rod 2 by welding or similar method. The cover member 4 has a cylinder-shaped portion 4a having an inner peripheral surface 4b. On the inner peripheral surface 4b, protruding portions 4c as locked portions are formed at four equally divided positions in a circumferential direction by cutting and raising the cylinder-shaped portion 4a to a side of the piston rod 2. The protruding portion 4c will be described in detail later.

The outer cover 5 is in a tubular shape. One end of the outer cover 5 is secured in the cylinder-shaped portion 4a of the cover member 4 by welding or similar method. The outer cover 5 is configured such that the length dimension of the outer cover 5 reaches an end portion of the tube 1 at a side of the capping member 3 when the shock absorber 100 is in the most extended state. This causes the outer cover 5 to protect the piston rod 2 from, for example, a stone flipped up while the automobile is moving.

The shock absorber 100 includes the capping member 3 as described above. In view of this, a circular-shaped clearance between the outer cover 5 and the capping member 3 is narrower than a circular-shaped clearance between the outer cover 5 and the tube 1 when the capping member 3 is not disposed. This reduces a dust or similar particle entering to a sliding surface side of the piston rod 2.

Subsequently, a description will be given of an operational advantage provided by constituting the shock absorber 100 as described above.

As described above, in the tube 1 of the shock absorber 100, the compressed gas is charged. In view of this, the shock absorber 100 is usually in the most extended state with the piston rod 2 being retreated from the tube 1 by a reactive force of the compressed gas.

Meanwhile, there is a request to keep the shock absorber in a contracted state until the shock absorber is assembled in the automobile or similar machine in order to improve a conveyance efficiency of the shock absorber and a work efficiency of assembling to the automobile or similar machine.

In contrast to this, with this embodiment, locking the protruding portion 4c disposed in the cover member 4 with the depressed portion 3b disposed in the capping member 3 can keep the shock absorber 100 in the contracted state.

When the shock absorber 100 is kept in the contracted state, firstly, the piston rod 2 is rotated to align positions in a rotational direction of the protruding portion 4c of the cover member 4 and the longitudinal groove portion 3c in the depressed portion 3b of the capping member 3. Then, the shock absorber 100 is contracted to insert the protruding portion 4c in the longitudinal groove portion 3c. At a point the shock absorber 100 is contracted to the position where the protruding portion 4c and the lateral groove portion 3d align in the circumferential direction, the piston rod 2 is rotated to move the protruding portion 4c to a position of the wide portion 3f. This locks the protruding portion 4c with the wide portion 3f to keep the shock absorber 100 in the contracted state against the reactive force of the compressed gas.

In a state where the protruding portion 4c is locked to the wide portion 3f, the protruding portion 4c is in contact with a step between the wide portion 3f and the lateral groove portion 3d to restrict the piston rod 2 from rotating. Accordingly, keeping the contracted state of the shock absorber 100 is not released without intention by, for example, vibration.

When the shock absorber 100 is extended, it is only necessary to contract the shock absorber 100 to the position where the protruding portion 4c and the lateral groove portion 3d align in the circumferential direction, and then to rotate the piston rod 2 to move the protruding portion 4c to the position of the longitudinal groove portion 3c.

Here, as another structure to thus keep the shock absorber in the contracted state, it is considered the structure where, for example, an engaging portion is formed by cutting and raising a bottom portion of a capping member to a side of a cover member and an engaging portion is formed by cutting and raising a top surface of the cover member to a side of the capping member to engage the engaging portion of the capping member with the engaging portion of the cover member.

However, this structure causes interference between the engaging portion of the capping member and the engaging portion of the cover member near the most contracted length when the shock absorber is in contraction operation. This causes a problem that a stroke of the shock absorber is restricted.

In contrast to this, in this embodiment, the depressed portion 3b is formed on the outer peripheral surface 3a of the capping member 3 and the protruding portion 4c is formed on the inner peripheral surface 4b of the cover member 4. Then, inserting the protruding portion 4c of the cover member 4 in the longitudinal groove portion 3c of the capping member 3 and moving the protruding portion 4c to the lateral groove portion 3d locks the protruding portion 4c to the depressed portion 3b to keep the shock absorber 100 in the contracted state. In view of this, while the above-described example cannot contract the shock absorber until the engaging portion of the cover member 4 comes in contact with the top surface of the capping member in the contraction operation of the shock absorber, this embodiment can contract the shock absorber 100 until the protruding portion 4c of the cover member comes in contact with the top surface 3e of the capping member 3. That is, this embodiment ensures achieving a structure to keep the shock absorber in the contracted state with the reduced influence on the stroke.

### Second Embodiment

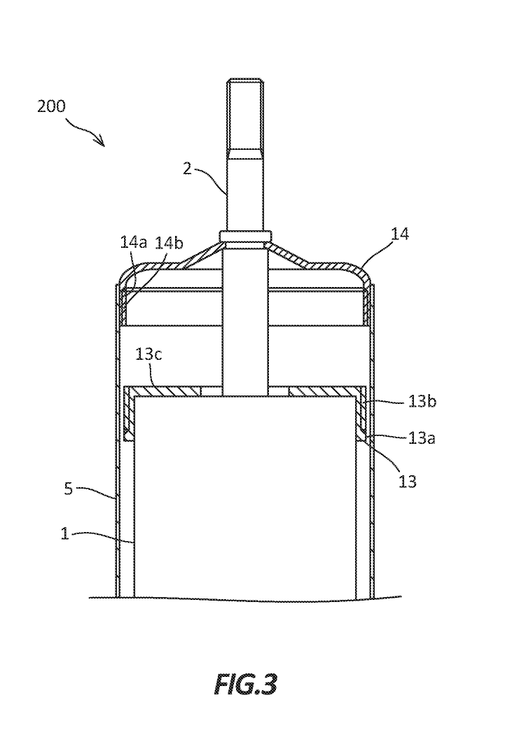

Next, the following describes a shock absorber 200 according to a second embodiment of the present invention by referring to FIG. 3.

The shock absorber 100 according to the first embodiment provides the depressed portion 3b formed on the outer peripheral surface 3a of the capping member 3 as the locking portion and the protruding portion 4c formed on the inner peripheral surface 4b of the cover member 4 as the locked portion. In contrast to this, the shock absorber 200 provides an external thread 13b formed on an outer peripheral surface 13a of a capping member 13 as the locking portion and an internal thread 14b formed on an inner peripheral surface 14a of a cover member 14 as the locked portion. Other configurations are identical to those of the first embodiment and identical reference numerals are designated to omit the explanation.

According to this embodiment, the external thread 13b is formed on the outer peripheral surface 13a of the capping member 13 and the internal thread 14b, which screws with the external thread 13b, is formed on the inner peripheral surface 14a of the cover member 14. Then, the internal thread 14b formed on the inner peripheral surface 14a of the cover member 14 and the external thread 13b formed on the outer peripheral surface 13a of the capping member 13 are screwed to keep the shock absorber 200 in the contracted state. In view of this, the shock absorber 200 can stroke until the internal thread 14b of the cover member 14 comes in contact with a top surface 13c of the capping member 13 in the contraction operation of the shock absorber 200. Accordingly, similar to the first embodiment, a structure that keeps the shock absorber in the contracted state with the reduced influence on the stroke can be achieved.

The following describes a configuration, an operation, and an effect according to the embodiment of the present invention together.

The shock absorbers 100 and 200 includes the tube 1, which has one end from which the piston rod 2 extends, the capping members 3 and 13, which are disposed in the end portions of the tube 1 on the one end side and include the locking portions (the depressed portion 3b and the external thread 13b) on the outer peripheral surfaces 3a and 13a, and the cover members 4 and 14, which are disposed in the distal end sides of the piston rod 2 and include the locked portions (the protruding portion 4c and the internal thread 14b) locked to the locking portions (the depressed portion 3b and the external thread 13b) on the inner peripheral surfaces 4b and 14a. The shock absorbers 100 and 200 are kept in the contracted state by the locked portions (the protruding portion 4c and the internal thread 14b) of the cover members 4 and 14 being locked to the locking portions (the depressed portion 3b and the external thread 13b) of the capping members 3 and 13.

In this configuration, the shock absorbers 100 and 200 can stroke until the locked portions (the protruding portion 4c and the internal thread 14b) of the cover members 4 and 14 come in contact with the top surfaces 3e and 13c of the capping members 3 and 13 in the contraction operation of the shock absorbers 100 and 200. Accordingly, it is possible to provide the shock absorber that is configured to be kept in the contracted state with the reduced influence on the stroke.

The locking portion of the shock absorber 100 is the depressed portion 3b, which includes the longitudinal groove portion 3c extending in the axial direction and the lateral groove portion 3d continuing from the longitudinal groove portion 3c and extending in the circumferential direction. The locked portion is the protruding portion 4c formed on the inner peripheral surface 4b of the cover member 4. Inserting the protruding portion 4c of the cover member 4 in the longitudinal groove portion 3c of the capping member 3 and moving the protruding portion 4c to the lateral groove portion 3d locks the protruding portion 4c to the depressed portion 3b.

In this configuration, the shock absorber 100 can stroke until the protruding portion 4c of the cover member 4 comes in contact with the top surface 3e of the capping member 3 in the contraction operation of the shock absorber 100. Accordingly, it is possible to provide the shock absorber that is configured to be kept in the contracted state with the reduced influence on the stroke.

The locking portion of the shock absorber 200 is the external thread 13b formed on the outer peripheral surface 13a of the capping member 13 and the locked portion is the internal thread 14b formed on the inner peripheral surface 14a of the cover member 14. Screwing the internal thread 14b of the cover member 14 with the external thread 13b of the capping member 13 keeps the shock absorber 200 in the contracted state.

In this configuration, the shock absorber 200 can stroke until the internal thread 14b of the cover member 14 comes in contact with the top surface 13c of the capping member 13 in the contraction operation of the shock absorber 200. Accordingly, it is possible to provide the shock absorber that is configured to be kept in the contracted state with the reduced influence on the stroke.

Embodiments of the present invention were described above, but the above embodiments are merely examples of applications of the present invention, and the technical scope of the present invention is not limited to the specific constitutions of the above embodiments.

For example, while in the above-described embodiment, the hydraulic oil is used as the operating fluid of the shock absorbers 100 and 200, other liquid, such as water, may be used.

While in the first embodiment, the depressed portions 3b of the capping member 3 and the protruding portions 4c of the cover member 4 are each disposed in the number of four, the number of the depressed portion 3b and the number of the protruding portion 4c may be three or less or may be five or more.

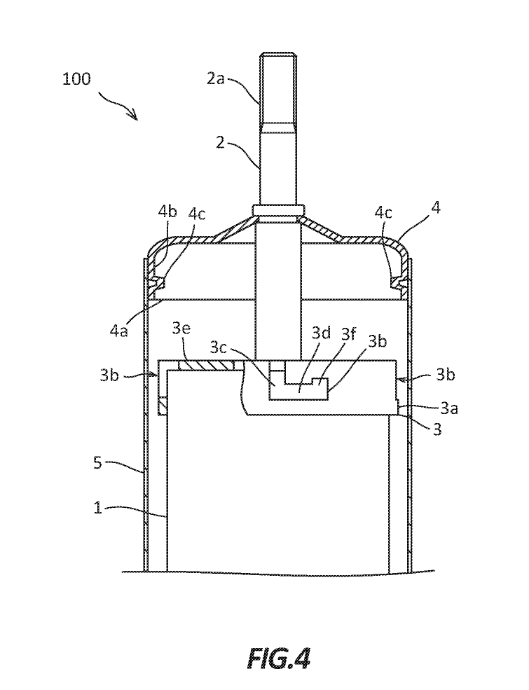

While in the first embodiment, the protruding portion 4c of the cover member 4 is formed by cutting and raising the cylinder-shaped portion 4a to the piston rod 2 side, for example, as illustrated in FIG. 4, the protruding portion 4c may be provided by forming a protrusion projecting to the piston rod 2 side in the cylinder-shaped portion 4a of the cover member 4.

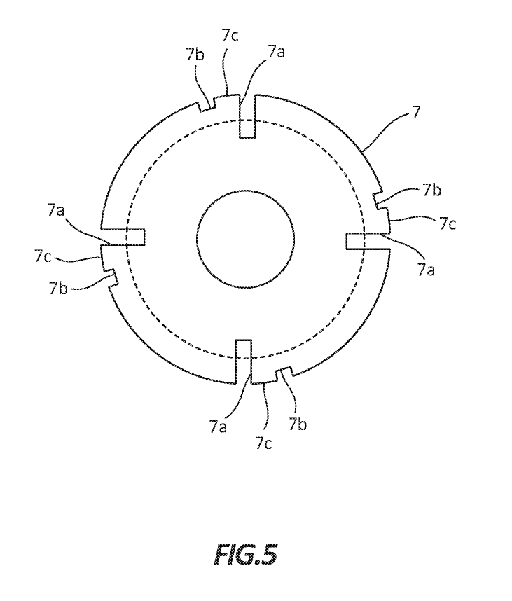

While in the first embodiment, the depressed portion 3b of the capping member 3 is formed by disposing the L-shaped slit 6a in the metal plate 6, for example, as illustrated in FIG. 5, the depressed portion 3b may be formed by disposing cutouts 7a and 7b in a circular-shaped metal plate 7. In this case, the cutout 7a corresponds to the longitudinal groove portion 3c, the cutout 7b corresponds to the wide portion 3f, and an outer peripheral portion 7c of the metal plate 7 corresponds to the lateral groove portion 3d. With this, the capping member 3 can be downsized and the material cost can be reduced. It should be noted that the capping members 3 and 13 may be a resin molded product.

With respect to the above description, the contents of application No. 2014-210058, with a filing date of Oct. 14, 2014 in Japan, are incorporated herein by reference.

1. A shock absorber comprising:
a tube that has one end from which a piston rod extends;
a capping member disposed in an end portion at a side of the one end in the tube, the capping member being in a shape of a cylinder with a closed bottom, the capping member including a locking portion formed on an outer peripheral surface of a cylinder-shaped portion; and
a cover member disposed in a distal end side of the piston rod, the cover member being in a shape of a cylinder with a closed bottom, the cover member including a locked portion locked to the locking portion formed on an inner peripheral surface of a cylinder-shaped portion, wherein
the shock absorber is kept in a contracted state by the locked portion of the cover member being locked to the locking portion of the capping member.

2. The shock absorber according to claim 1, wherein
the locking portion is a depressed portion including a longitudinal groove portion extending in an axial direction and a lateral groove portion continuing from the longitudinal groove portion and extending in a circumferential direction,
the locked portion is a protruding portion formed on the inner peripheral surface of the cover member, and
the protruding portion of the cover member is inserted in the longitudinal groove portion of the capping member and moved to the lateral groove portion to lock the protruding portion to the depressed portion.

3. The shock absorber according to claim 1, wherein
the locking portion is an external thread formed on the outer peripheral surface of the capping member,
the locked portion is an internal thread formed on the inner peripheral surface of the cover member, and
the shock absorber is kept in a contracted state by the internal thread of the cover member being screwed with the external thread of the capping member.

4. The shock absorber according to claim 2, wherein
the longitudinal groove portion extends to a bottom portion of the capping member.
